(19) United States
(12) Patent Application Publication
(10) Pub. No.: US 2016/0008854 A1
(43) Pub. Date: Jan. 14, 2016

(54) CLEANING INSTALLATION FOR INDUSTRIALLY MANUFACTURED COMPONENTS

(71) Applicant: TMS TURNKEY MANUFACTURING SOLUTIONS GMBH, Linz (AU)

(72) Inventors: Reiner WITTENDORFER, Linz (AT); Martin ARMBRUSTER, Gallneukirchen (AT); Peter EMBACHER, Ramingstein (AT)

(73) Assignee: TMS TURNKEY MANUFACTURING SOLUTIONS GmbH, Linz (AT)

(21) Appl. No.: 14/772,939

(22) PCT Filed: Feb. 4, 2014
(86) PCT No.: PCT/EP2014/052088

§ 371 Date: Sep. 4, 2015

(30) Foreign Application Priority Data
Mar. 6, 2013 (DE) 20 2013 100 959.8

(51) Int. Cl. B08B 3/04

(52) U.S. Cl. CPC B08B 3/04

(57) ABSTRACT

In order to keep the base surface of a cleaning system for industrially manufactured components as small as possible, it is provided that the process chambers (4, 5, 23) and the robot chamber (3) of the cleaning system are disposed on a base plate (7), wherein the base surface (8) of the base plate (7) is greater than the common base surface (9) of the process chambers (4, 5, 23) and the robot chamber (3), and at least two spatially separate hollow spaces (10, 11, 20) to accommodate the process fluids being provided in the base plate (7), wherein the hollow spaces (10, 11, 20) in each case extend at least partially below the process chamber (4, 5, 23) and extend at least partially outside the common base surface (9) of the process chambers (4, 5, 23) and the robot chamber (3), and at least one hydraulic component of a hydraulic circuit is disposed on the base plate (7) above at least one hollow space (10, 11, 20).

The present invention relates to a cleaning system for industrially manufactured components with at least two process chambers spatially separated from one another and an adjacent robot chamber spatially separated therefrom, said chambers being disposed on a common base plate, wherein each process chamber is provided with its own hydraulic circuit for conveying a process fluid into the process chamber.

In industrial production processes, in particular in machining processes, the manufactured components must be cleaned before they can be further processed. The cleaning processes necessary therefor are complex and generally require a plurality of cleaning stages occurring one after the other, such as for example prewashing, main washing, fine washing and drying, in order to be able to achieve the required degree of cleanness. In addition, different cleaning media can also be used for this purpose. However, working steps such as, for example, the deburring of the components, typically form part of the cleaning process. For this purpose a plurality of automatic or semiautomatic cleaning systems which provide this are known from the prior art.

DE 10 2005 003 093 A1 shows, for example, a cleaning system with a plurality of cleaning chambers which are disposed adjacent to one another for carrying out different cleaning processes and are operated by different robots. However, this arrangement requires a relatively large base surface and also relatively complex pipework in order to be able to supply all cleaning chambers with the required process fluids.

WO 2010/062894 A1 shows a cleaning system with a robot chamber and a plurality of process chambers. Hollow spaces to accommodate the respective process fluids are provided in the base of the robot chamber or in the bases of the process chambers. The required hydraulic components for conveying these process fluids must either be disposed alongside, for example, as here, after the robot chamber, but this necessitates substantial expenditure for the necessary pipework. Or the necessary components are accommodated directly in the hollow spaces, but they are very difficult to access for maintenance purposes.

Therefore it was an object of the present invention to provide a cleaning system which can be produced with the smallest possible base surface and is therefore extremely compact and in which the cost of the required hydraulic circuits for conveying the process fluids to the cleaning system can be kept as low as possible.

This object is achieved in that the process chambers and the robot chamber form a common base surface and the base plate forms a base surface, wherein the base surface of the base plate is greater than that of the common base surface of the process chambers and the robot chamber, at least two spatially separate hollow spaces to accommodate the process fluids being provided in the base plate, wherein the hollow spaces in each case extend at least partially below the process chamber and at least partially outside the common base surface of the process chambers and the robot chamber and at least one hydraulic component of a hydraulic circuit is disposed on the base plate above at least one hollow space. Due to this arrangement, on the one hand, the necessary hydraulic components can be disposed in close proximity to the process chambers and above all with short pipe lengths. In this case these components are also freely accessible for maintenance purposes. Last but not least, as a result, the base surface of the cleaning system can nevertheless be kept as small as possible.

If the process chambers are disposed adjacent to and above one another, a particularly compact cleaning system with a very small base surface can be achieved.

The process chambers are preferably spatially separated from one another by a double wall, so that a good thermal decoupling of the adjacent process chambers is achieved. In this way a heat input from one process chamber into another, and thus also an energy loss, can be decreased.

If the process chambers are configured with rounded inner edges, they can be more easily cleaned, since no dirt can be deposited in sharp corners which are difficult to access.

The cleaning system can be supplemented in a simple manner by additional cleaning devices if these are disposed in the robot chamber, wherein the additional cleaning device is preferably connected to a hollow space order in turn to reduce the pipework.

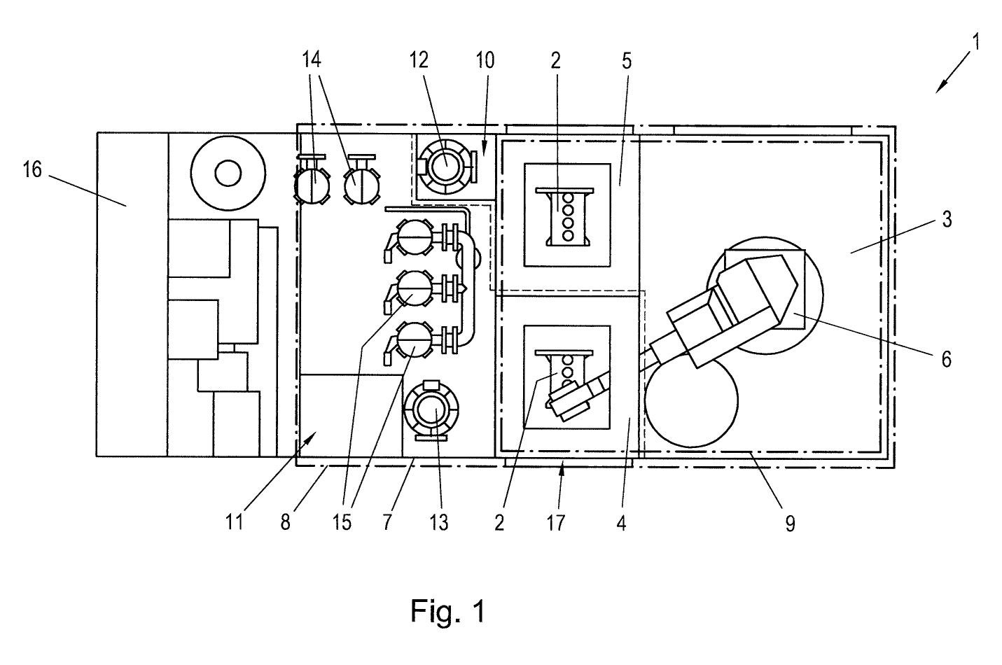

The present invention is explained in greater detail below with reference to FIGS. 1 to 5, which show by way of example, schematically and without limitation, advantageous embodiments of the invention. In the drawings:

FIG. 1 shows the plan view of a cleaning system according to the invention,

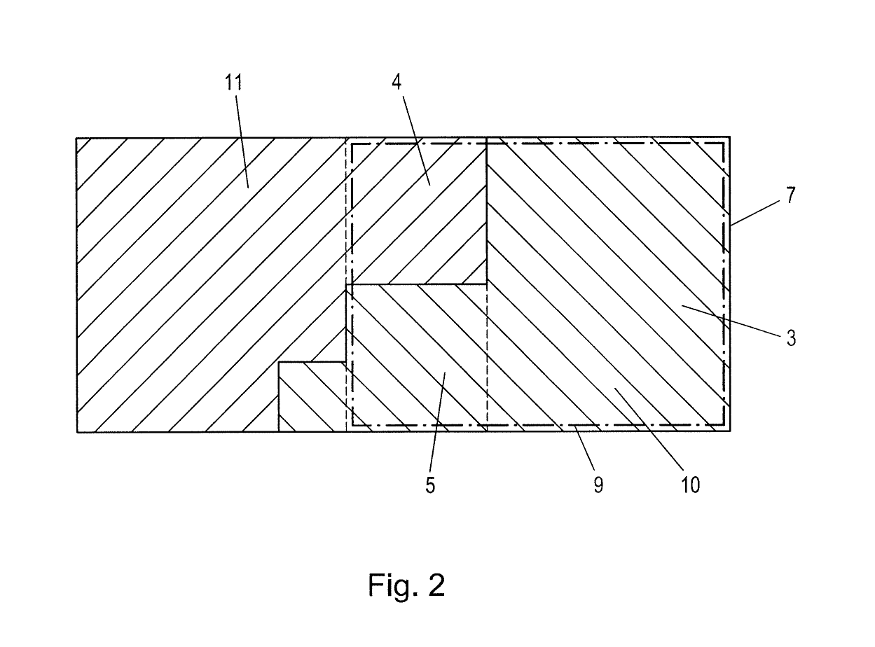

FIG. 2 shows a view from below the cleaning system according to the invention,

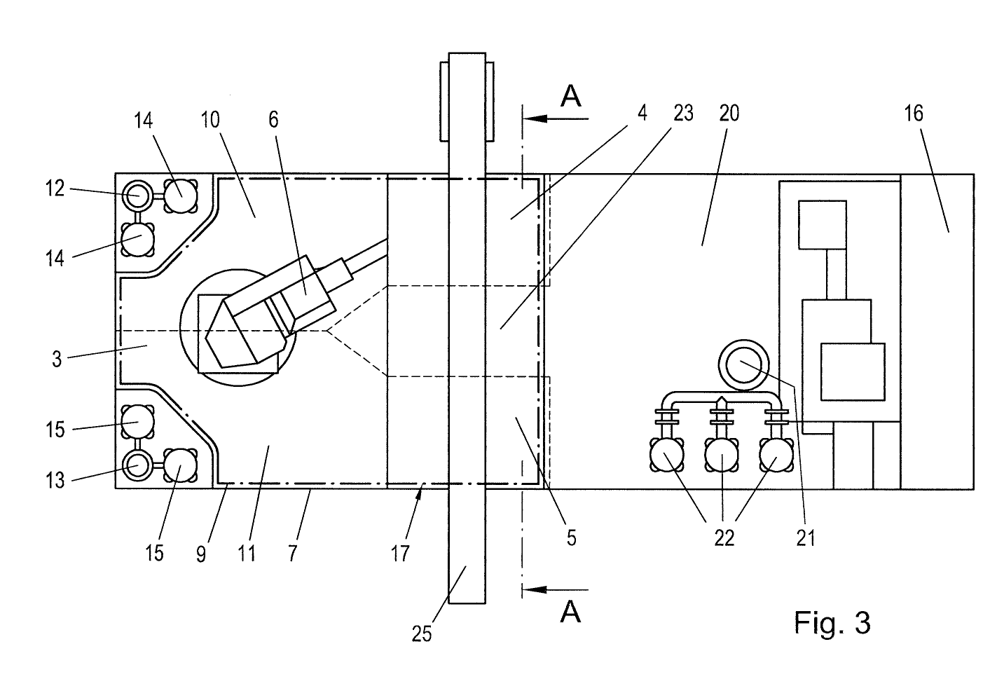

FIG. 3 shows the plan view of a further embodiment of a cleaning system according to the invention,

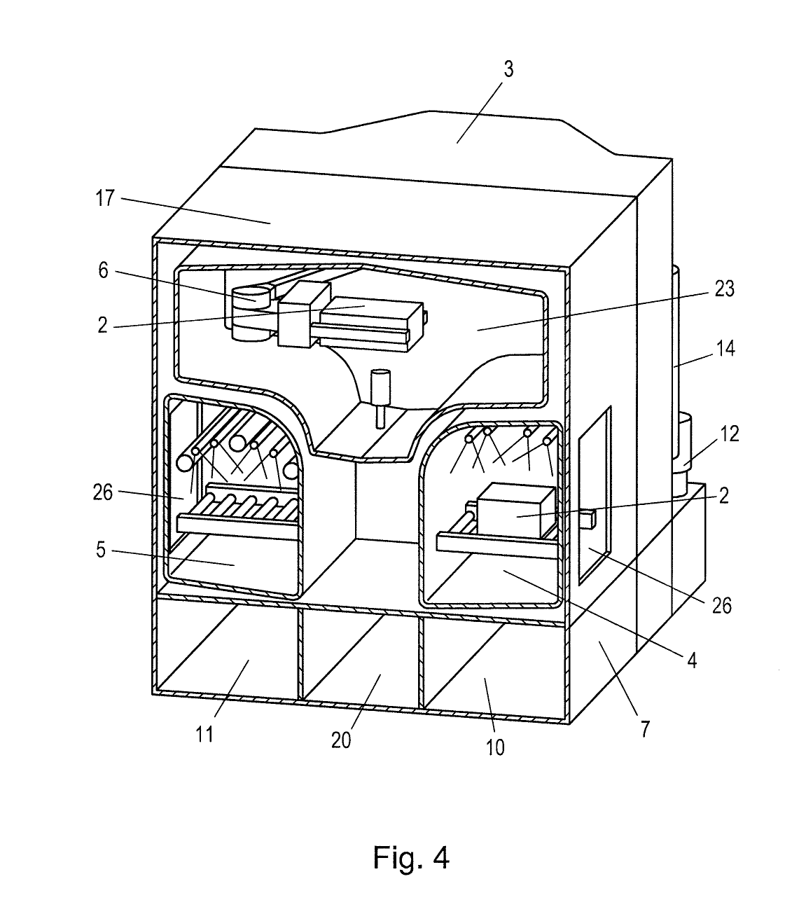

FIG. 4 shows a detail view of the process chambers of a cleaning system according to the invention, and

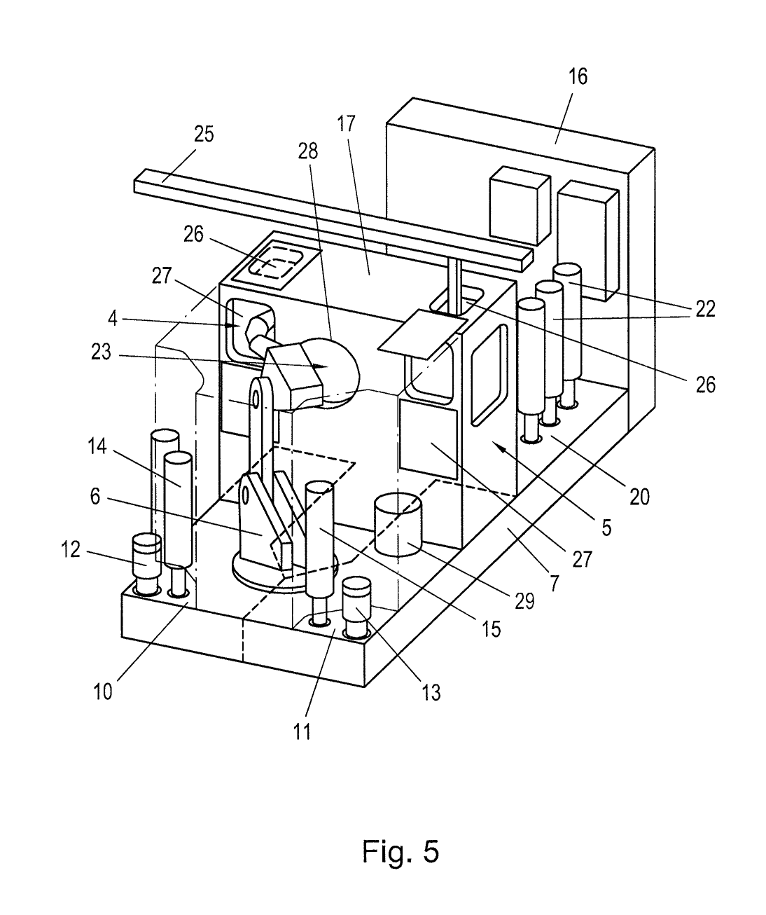

FIG. 5 shows a perspective view of a cleaning system according to the invention.

FIG. 1 shows an embodiment of an industrial cleaning system 1 for cleaning components 2, such as for example engine blocks, cylinder heads, crankshafts, etc., which are manufactured industrially, in particular by a machining production process. In this exemplary embodiment the cleaning system 1 comprises a robot chamber 3, in which an industrial robot 6 for handling the components 2 is disposed in the cleaning system 1. Two process chambers 4, 5 are disposed immediately adjacent to the robot chamber 3. The robot chamber 3 and the process chambers 4, 5 are spatially separated from one another, for example by corresponding partitions, and are closed off towards the exterior. Air-locks 27 (FIG. 5), which can be opened and closed, are disposed between the robot chamber 3 and the process chambers 4, 5 in order to be able to move the components 2 in the cleaning system 1. Furthermore, at least one door 26, which can be opened and closed, is provided on a process chamber 4, 5 or on the robot chamber 3 in order be able to move components 2 into and out of the cleaning system 1.

In addition, an electrical switch cabinet 16, preferably having a control panel with monitor and input devices, is also disposed in the cleaning system 1 in order to be able to operate the cleaning system 1. In this case the switch cabinet 16 is preferably disposed on the end of the cleaning system 1 opposite the robot chamber 3.

Well known cleaning devices, such as for example nozzles, sprinklers, blowers, etc., for cleaning the components 2 are disposed in the process chambers 4, 5 and are not discussed in detail. For example, the process chamber 4 may be configured as a prewashing chamber and the process chamber 5 may be configured as a fine washing and drying chamber. The cleaning in the process chambers 4, 5 takes place in each case with a process fluid, which is delivered to the process chambers 4, 5, or the cleaning devices therein, by means of a hydraulic circuit for conveying the process fluid via a pipe system.

The process chambers 4, 5 and the robot chamber 3 are disposed on a common base plate 7. In this case the base surface 8 (indicated by the bold dash-dot line in FIG. 1) of the base plate 7 is greater than that of the common base surface 9 (indicated by the second bold dash-dot line in FIG. 1) of the process chambers 4, 5 and the robot chamber 3. Thus in a plan view the base plate 7 projects over the process chambers 4, 5 and the robot chamber 3.

In the base plate 7 at least one hollow space 10, 11 for a process fluid is in each case provided at least for each process chamber 4, 5, as is shown in a view from below in FIG. 2, wherein the hollow spaces 10, 11 are separated from one another spatially, for example by corresponding partitions in the base plate 7. The hollow spaces 10, 11 extend in each case at least partially below the process chambers 4, 5 and in each case at least partially outside the common base surface 9 of the process chambers 4, 5 and the robot chamber 3. Thus on the base plate 7 for each hollow space 10, 11 a region is created, by means of which access to the hollow spaces 10, 11 is gained directly and by the shortest route. Thus hydraulic components, such as for example a pump 12, 13 or a filter 14, 15, of a hydraulic circuit for a process fluid can be disposed in this free region of the base plate 7 (FIG. 1). At the same time as a result the process fluid can be directed by the shortest route out of the hollow space 10, 11 into the associated process chamber 4, 5 disposed thereabove, or can be directed back out of said chamber into the associated hollow space 10, 11. In this way a minimum of necessary pipework is achieved, which is directly reflected in a saving of space and cost. Moreover, these hydraulic components remain easily accessible for maintenance purposes.

A cleaning system 1 with three process chambers 4, 5, 23 is shown in FIG. 3. Three hollow spaces 10, 11, 20 are provided in the base plate 7, wherein in turn each hollow space 10, 11, 20 extends at least partially below an associated process chamber 4, 5, 23 and each hollow space 10, 11, 20 extends at least partially outside the common base surface 9 of the process chambers 4, 5, 23 and the robot chamber 3. If the same process fluid is used in two process chambers, two hollow spaces in the base plate 7 may be sufficient, as two process chambers are supplied from the same hollow space. Again hydraulic components, such as for example the pumps 12, 13, 21 or filters 14, 15, 22 of the hydraulic circuits for the process fluids are disposed on the region of the base plate 7 which has thus become free. For this purpose the corners of the robot chamber 3 are recessed at their end lying opposite the process chambers 4, 5, 23 in order to create space for the hydraulic components, the pumps 12, 13 and filters 14, 15, in this region on the base plate 7 and thus to make the fullest possible use of the available space and to keep the required base surface of the cleaning system 1 as small as possible.

FIG. 3 also shows by way of example a conveying device 25 by which the components 2 can be transported to and away from the cleaning system 1. In this case the components 2 can either be transported from above into a process chamber 4, 5, 23 or, as in FIG. 4, from the side by means of roller tracks.

FIG. 4 shows a section through the process chambers 4, 5, 23 of FIG. 3 along the line A-A. The process chambers 4, 5, 23 in this case are disposed adjacent to and above one another in a wall-like process housing 17 in a compact manner with the best possible utilization of space. The process housing 17 directly adjoins the robot chamber 3. The process chamber 4, which serves as a prewashing chamber, and the process chamber 5, which serves as a fine washing chamber, can be of very compact design with limited installation space. The process chamber 23 serving as a main washing chamber is disposed between and above these two process chambers 4, 5, and requires more space, since the component 2 can also be moved therein for cleaning, for example by the robot 6 or by a device disposed therein. FIG. 3 also shows the arrangement of the process chambers 4, 5, 23 directly above the associated hollow spaces 10, 11, 20, in order to gain access in the most direct way to the associated process fluid.

The process chambers 4, 5, 23 are preferably separated from one another spatially by a double wall. Since the cleaning processes in the various process chambers 4, 5, 23 can take place with process fluids at different temperatures, the double wall serves for an improved thermal decoupling and isolation of the cleaning processes, so that energy can be saved for regulating the temperature of the process fluids.

The process chambers 4, 5, 23 are also preferably designed with rounded inner edges, which makes the deposition of dirt difficult, especially in the corners of the process chambers 4, 5, 23. Thus maintenance intervals for cleaning the process chambers 4, 5, 23 can be extended, and at the same time the cleaning of the process chambers 4, 5, 23 is simplified thereby. Lateral doors 26 are provided on two process chambers 4, 5 in order to be able to move components 2 into or out of the cleaning system 1.

In FIG. 5 the housing of the robot chamber 3 has been cut away. Therefore it is possible to see the air-locks 27 between the robot chamber 3 and the process chambers 4, 5. In the exemplary embodiment illustrated here no air-lock is provided between the process chamber 23 and the robot chamber 3, but only an opening 28, since the robot 6 holds and positions the component 2 in the process chamber 23 for cleaning. Naturally, however, the component 2 could also be set down in the process chamber 23 and then an air-lock could be provided between the process chamber 23 and the robot chamber 3.

A conveying device 25 brings the components 2 to be cleaned to the cleaning system 1 and introduces the components 2, as here, from above through a door 26 into a first process chamber 5, for example for prewashing. Then the robot 6 takes up the component 2 and moves it into the process chamber 23 for the main washing and then onwards into a further process chamber 4, for example for fine washing and for drying. From this process chamber 4 the component 2 can then be transported away again by means of the conveying device 25. In this case the sequences in the cleaning system 1 are monitored and controlled by the switch cabinet 16 and associated sensors and actuators (not shown).

However, in addition the space in the robot chamber 3 may also be used in order to dispose therein additional cleaning devices 29, such as for example flow washing bowls or ultrasonic bowls, as indicated in FIG. 5. In this connection it may be provided that the hollow space 20, which is associated here with the process chamber 23 serving as a main washing chamber, also extends below the robot chamber 23, as illustrated in FIG. 3 and FIG. 5. Thus in the robot chamber 3 access can also be gained by a simple and direct route to the process fluid located therein, in order to, for example, also operate the additional cleaning device 28 in the robot chamber 3.

In particular, however, in the case of a process chamber 23 which is open towards the robot chamber 3, it is also advantageous if the hollow space 20 also extends below the robot chamber 3, since splashing process fluid from the process chamber 23 which collects in the robot chamber in a simple and direct way can then be returned into the hollow space 20, for example through a correspondingly inclined base surface of the robot chamber, in order to produce a natural gradient in the direction of the hollow space 20.

Of course, it is also conceivable to dispose process chambers 4, 5, 23 on both sides of the robot chamber 3, so that further cleaning processes could be implemented. For this purpose these further process chambers could again be disposed on the base plate 7 and above associated hollow spaces therein.

1. Cleaning system for industrially manufactured components (2) with at least two process chambers (4, 5, 23) spatially separated from one another for cleaning the components (2) and an adjacent robot chamber (3) spatially separated therefrom to accommodate a robot for handling the components (2) in the cleaning system, said chambers being disposed on a common base plate (7), wherein each process chamber (4, 5, 23) is provided with its own hydraulic circuit for conveying a process fluid into the process chamber (4, 5, 23), characterized in that the process chambers (4, 5, 23) and the robot chamber (3) form a common base surface (9) and the base plate (7) forms a base surface (8), wherein the base surface (8) of the base plate (7) is greater than the common base surface (9) of the process chambers (4, 5, 23) and the robot chamber (3), that at least two spatially separated hollow spaces (10, 11, 20) to accommodate the process fluids are provided in the base plate (7), wherein the hollow spaces (10, 11, 20) in each case extend at least partially below the process chamber (4, 5, 23) and extend at least partially outside the common base surface (9) of the process chambers (4, 5, 23) and the robot chamber (3), and that at least one hydraulic component of a hydraulic circuit is disposed on the base plate (7) above at least one hollow space (10, 11, 20).

2. Cleaning system according to claim 1, characterized in that the process chambers (4, 5, 23) are disposed adjacent to and above one another.

3. Cleaning system according to claim 1, characterized in that the process chambers (4, 5, 23) are separated from one another spatially by a double wall.

4. Cleaning system according to claim 1, characterized in that the process chambers (4, 5, 23) are designed with rounded inner edges.

5. Cleaning system according to claim 1, characterized in that an additional cleaning device (29) is disposed in the robot chamber (3).

6. Cleaning system according to claim 5, characterized in that the additional cleaning device (29) is connected to a hollow space (10, 11, 20).
